(19) United States
(12) Patent Application Publication
(10) Pub. No.: US 2013/0193246 A1
(43) Pub. Date: Aug. 1, 2013

(54) SPICE MILL WITH INTERCHANGEABLE SPICE CONTAINERS

(71) Applicant: Daniel James Roberts, JR., Austin, TX (US)

(72) Inventor: Daniel James Roberts, JR., Austin, TX (US)

(21) Appl. No.: 13/741,026

(22) Filed: Jan. 14, 2013

Related U.S. Application Data
(60) Provisional application No. 61/585,939, filed on Jan. 12, 2012.
(60) Provisional application No. 61/614,321, filed on Mar. 22, 2012.

(51) Int. Cl. A47J 42/50; A47J 42/46; A47J 42/44

(52) U.S. Cl. CPC A47J 42/50; A47J 42/44; A47J 42/46
USPC 241/36; 241/169.1; 241/101.2

(57) ABSTRACT

This disclosure describes systems and methods for grinding and reducing spices prior to application of the spices. In some embodiments, a spice grinding system may include a powered base and at least a first spice container. The powered base may include an electric motor and a control system. The control system may function to activate the electric motor. The first spice container may be releasably couplable to the powered base. In some embodiments, the first spice container may include a first opening in the first spice container configured to contain spice. In some embodiments, the first spice container may include a grinding mechanism. The powered base may function to rotate a portion of the first spice container and simultaneously inhibit another portion of the first spice container from rotating, in order to grind/sift spice in the first spice container.

### PRIORITY CLAIM

This application claims priority to U.S. Provisional Patent Application No. 61/585,939 entitled “SPICE MILL WITH INTERCHANGEABLE SPICE CONTAINERS” to Roberts, Jr. filed on Jan. 12, 2012, and U.S. Provisional Patent Application No. 61/614,321 entitled “SPICE MILL WITH INTERCHANGEABLE SPICE CONTAINERS” to Roberts, Jr. filed on Mar. 22, 2012, all of which are incorporated by reference herein.

### BACKGROUND OF THE INVENTION

1. Field of the Invention

The present disclosure generally relates to spice grinding devices. More particularly, the disclosure generally relates to systems for grinding spices into smaller more pungent material, the system including interchangeable spice containers.

2. Description of the Relevant Art

Different kinds of spice mills are utilized to grind products in bulk and to dispense ground spice products directly onto food. Portable spice mills are used to provide ground spices which provides an enhanced smell and flavor of the spices. Due to the enhanced qualities of ground spices, less spice is needed when it is ground prior to use as the smell and taste components are enhanced. Powered spice grinders are known in the art; however, purchasing a different powered spice grinder for every available spice (or even for just a few common ones) is cost prohibitive for most families as well as the problems associated with storage of so many spice grinders in today's already crowded kitchens. Improving the efficiency and cost effectiveness of spice grinders is desirable.

U.S. Pat. No. 7,533,838 issued to Kalogroulis et al. (hereinafter “Kalogroulis”) discloses a spice mill uses one touch button control and a common driven shaft to operate a pair of oppositely disposed grinding mills simultaneously. However, Kalogroulis does not disclose a powered spice mill with interchangeable spice containers.

U.S. Pat. No. 6,377,022 issued to Rhoads (hereinafter “Rhoads”) discloses a A rechargeable coffee or spice grinding apparatus having a grinder and a charging station. However, Rhoads does not disclose a powered spice mill with interchangeable spice containers. Although there exist many different types of spice grinders, none of the known devices accomplish what the herein described measuring device is capable of.

What is needed is a device which allows one to easily and conveniently exchange different spices into and out of a powered spice grinder.

### SUMMARY

This disclosure describes systems and methods for grinding and reducing spices prior to application of the spices. In some embodiments, a spice grinding system may include a powered base and at least a first spice container. The powered base may include an electric motor and a control system. The control system may function to activate the electric motor. The first spice container may be releasably couplable to the powered base. In some embodiments, the first spice container may include a first opening in the first spice container configured to contain spice. The powered base may function to rotate a portion of the first spice container and simultaneously inhibit another portion of the first spice container from rotating, in order to grind/sift spice in the first spice container.

In some embodiments, the first spice container may include a grinding mechanism. The grinding mechanism may inhibit spice positioned in the first opening from exiting the first opening prior to activation of the grinding mechanism by the electric motor. The grinding mechanism may function to grind the spice, upon activation, such that the spice is reduced in to such an extent as to pass out of the first opening and through the grinding mechanism.

In some embodiments, a powered base may include an energy source. The energy source may be rechargeable. A spice grinding system may include a recharging station. The recharging station may function to electrically couple to the rechargeable energy source during use.

In some embodiments, a first spice container may include a first spice. In some embodiments, a first spice container may be disposable. In some embodiments, a first spice container may be reusable. The first spice container may be refilled. The first spice container may be refilled by adding spice through a second opening in the first spice container. In some embodiments, a spice grinding system may include at least a second spice container. The second spice container may include a second spice. The first and second spice may be the same or different spices.

In some embodiments, a first spice container may include at least one transparent portion such that materials contained therein may be observed by a user. At least a portion of the powered base may be transparent such that spice in the first spice container can be viewed by a user when the first spice container is substantially in an opening of the powered base.

In some embodiments, a grinding mechanism may include a burr grinder. A grinding mechanism may include at least one ceramic grinder. A grinding mechanism may include at least one plastic grinder.

In some embodiments, a spice grinding system may include a storage system. A storage system may function to contain and/or organize a plurality of spice containers.

In some embodiments, a powered base may include a control system. The control system may function to activate an electric motor. The control system may function to activate the electric motor for a specified amount of time such that a predetermined amount of spice is ground and dispensed. The amount of time may be set by a user.

In some embodiments, the powered base may include a light. The light, during use, may light up an area substantially adjacent the grinding mechanism of the first spice container. The light may be activated by the controller during use.

In some embodiments, the first spice container may be positioned in an opening of the powered base. A first portion of the opening of the powered base may include a shape at least partially complementary to a first end portion of the first spice container housing the grinding mechanism. A second portion of the opening of the powered base may include a second shape at least partially complementary to a second end, opposite the first end, of the first spice container such that when the electric motor is activated the second portion of the opening rotates engaging and rotating the second end portion of the first spice container while the first portion of the opening engages the first end portion of the first spice container inhibiting rotational movement of the first end portion as the second end portion is rotated.

In some embodiments, at least one of the second portion of the opening or the second end portion of the first spice container may include at least three cornered portions and the other of the second portion of the opening or the second end portion of the first spice container may include at least three elongated members. In some embodiments, at least one of the first portion of the opening or the first end portion of the first spice container may include at least two splines and the other of the first portion of the opening or the first end portion of the first spice container may include at least two indentations.

In some embodiments, the powered base may include a lock. The lock which, when activated during use, may inhibit the first spice container from decoupling from the powered base. The lock may include at least one locking member which each engage a depression on the first spice container upon insertion of the first spice container in the opening of the powered base. At least one of the locking members may include at least a portion of a ring which engages at least a majority of the depression substantially extending around at least a portion of a circumference of the first spice container.

In some embodiments, the grinding/sifting mechanism comprises a grinding/sifting selector which, upon activation, changes an average size of the ground spice.

In some embodiments, a method of grinding spices may include using a system as described herein.

In some embodiments, a method of grinding spices may include coupling a first spice container to a powered base. The first spice container may include a first spice positioned in a first opening of the first spice container. The method may include activating a control system to activate an electric motor. The electric motor may be positioned in the powered base. The method may include grinding at least a portion of the first spice using a grinding mechanism powered by the electric motor. The method may include decoupling the first spice container from the powered base. The method may include coupling a second spice container to a powered base. The second spice container may include a second spice positioned in a second opening of the second spice container. The method may include activating the control system to activate the electric motor. The method may include grinding at least a portion of the second spice using a second grinding mechanism powered by the electric motor.

### BRIEF DESCRIPTION OF THE DRAWINGS

Advantages of the present invention may become apparent to those skilled in the art with the benefit of the following detailed description of the preferred embodiments and upon reference to the accompanying drawings.

FIG. 1 depicts a diagram of a perspective view of an embodiment of at least a portion of a spice grinding system.

FIG. 2 depicts a diagram of a perspective view of an embodiment of at least a portion of a spice grinding system.

FIG. 3 depicts a diagram of a perspective view of an embodiment of a first spice container of a spice grinding system.

FIG. 4 depicts a diagram of a perspective view of an embodiment of a powered base of a spice grinding system.

FIG. 5 depicts a diagram of a top view of an embodiment of a recharging station of a spice grinding system.

FIG. 6 depicts a diagram of a perspective view of an embodiment of a recharging station of a spice grinding system.

FIG. 7 depicts a diagram of a front view of an embodiment of a storage system of a spice grinding system.

FIG. 8 depicts a diagram of a side view of an embodiment of a spice grinding system.

FIG. 9 depicts a diagram of a side view of an embodiment of a first spice container of a spice grinding system.

FIG. 10 depicts a diagram of a side view of an embodiment of at least a portion of a spice grinding system.

FIG. 11 depicts a diagram of a side view of an embodiment of a bottom portion of a spice grinding system.

FIG. 12 depicts a diagram of a perspective view of an embodiment of a spice grinding system including a recharging station.

FIG. 13 depicts a diagram of a perspective view of an embodiment of a recharging station of a spice grinding system.

FIG. 14 depicts a diagram of a bottom perspective view of an embodiment of powered base of a spice grinding system.

FIG. 15 depicts a diagram of a side view of an embodiment of a first spice container of a spice grinding system.

FIG. 16 depicts a diagram of a perspective exploded view of an embodiment of a first spice container of a spice grinding system.

While the invention is susceptible to various modifications and alternative forms, specific embodiments thereof are shown by way of example in the drawings and may herein be described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

It is to be understood the present invention is not limited to particular devices or biological systems, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Thus, for example, reference to “a linker” includes one or more linkers.

### DEFINITIONS

Unless defined otherwise, all technical and scientific terms used herein have the same meaning as commonly understood by one of ordinary skill in the art.

The term “connected” as used herein generally refers to pieces which may be joined or linked together.

The term “coupled” as used herein generally refers to pieces which may be used operatively with each other, or joined or linked together, with or without one or more intervening members.

The term “directly” as used herein generally refers to one structure in physical contact with another structure, or, when used in reference to a procedure, means that one process effects another process or structure without the involvement of an intermediate step or component.

The term “end portion” as used herein generally refers an end and the portion near the end.

The term “spice” as used herein generally refers to a dried organic or inorganic material used as a food additive for flavor, color, and/or as a preservative. Inorganic materials may include salt for example.

In some embodiments, a spice grinding system may function to grind or reduce in size spices for application to enhance the innate qualities of the spices. A spice grinding system may include an electrically powered motor. A spice grinding system may allow the exchange of different spice containers with the spice grinding system. Exchanging different spice containers in the spice grinding system may allow for a more efficient system reducing costs to the user and reducing storage requirements when not in use, as opposed to a user having to purchase a different grinder for each spice or manually exchanging the spice itself in a spice grinder.

In some embodiments, a spice container of a spice grinding system may contain ground spices which do not require further grinding (e.g., paprika, cayenne) such that the spice container does not grind the contained spice further but merely dispenses the spices. In such embodiments, the spice container may or may not include a grinding mechanism.

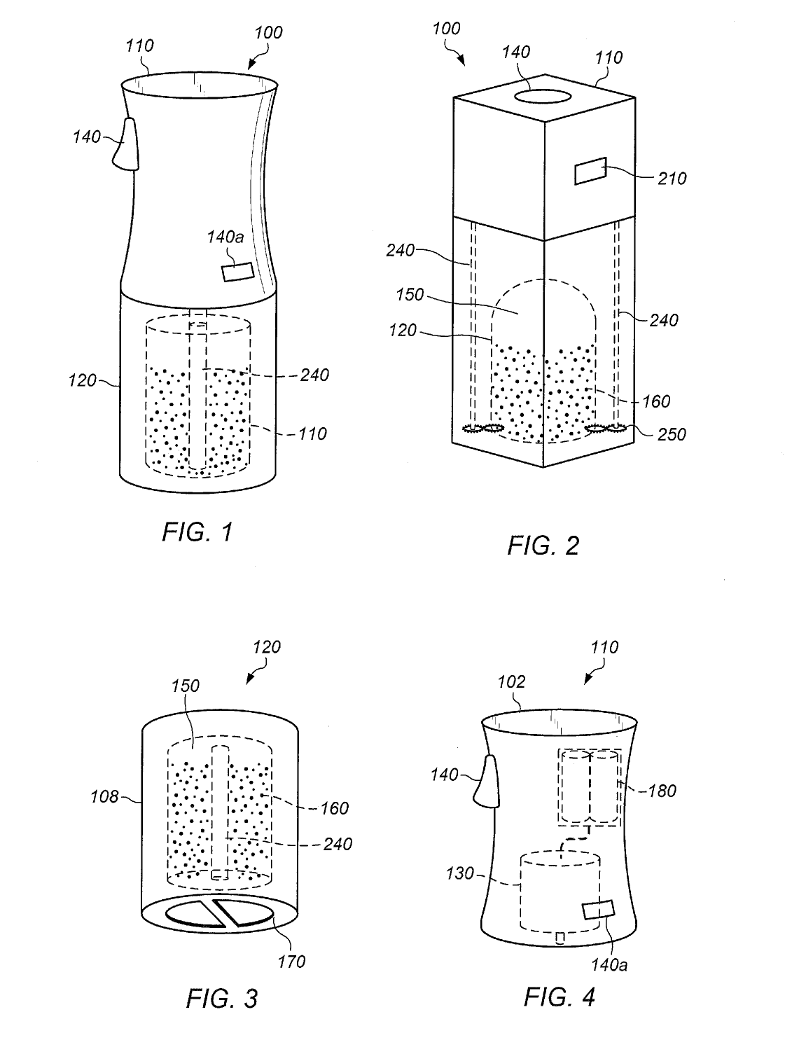

This disclosure describes systems and methods for efficient grinding and reducing of, for example, multiple different spices prior to application of the spices. FIGS. 1-2 depicts a diagram of a perspective view of an embodiment of at least a portion of spice grinding system 100. In some embodiments, a spice grinding system may include powered base 110 and at least first spice container 120. Powered base 110 may include electric motor 130 and control system 140. The control system may function to activate the electric motor.

FIG. 3 depicts a diagram of a perspective view of an embodiment of first spice container 120 of spice grinding system 100 (embodiment depicted in FIG. 1). First spice container 120 may be releasably couplable to powered base 110. The first spice container may be releasably coupled to the powered base using control system 140a. In some embodiments, first spice container may include first opening 150 in the first spice container configured to contain spice 160. In some embodiments, first spice container 120 may include a grinding mechanism 170. The grinding mechanism may inhibit spice positioned in the first opening from exiting the first opening prior to activation of the grinding mechanism by the electric motor. Herein grinding mechanism may not only refer to grinding spice but also to sifting spice. The grinding mechanism may function to grind the spice, upon activation, such that the spice is reduced in to such an extent as to pass out of the first opening and through the grinding mechanism. In some embodiments, the grinding mechanism may include a grinding selector which, upon activation, changes an average size of the ground spice. In some embodiments, a grinding selector may include a cover with different sized holes in different areas of the cover such that a spice may be sprinkled, poured, or inhibited from coming out (in the case of an area with no opening).

In some embodiments, spice container 120 may be positionable in at least a portion of powered base 110 (e.g., as depicted in FIG. 2). The spice container may be inserted in an opening in the bottom of the spice container.

In some embodiments, a first spice container may include a first spice. In some embodiments, a first spice container may be disposable. Spice containers may be such that they are constructed inexpensively, for example, from materials which may not last for an extended period of time with heavy use. For example, grinding gears may be formed from plastics instead of ceramics or metals. Disposable spice containers may be formed from less durable materials in general in order to save money during manufacture of the disposable containers. Disposable spice containers may create a separate revenue stream for a manufacturer, as spice in a container are used up, replacement spice containers required by purchasers of the grinding system must then be purchased from the manufacturer of the grinding system. In some embodiments, disposable spice container may be manufactured such that they are effectively sealed. The disposable spice containers may be sealed such that they are not easily opened and refilled with spice once the originally loaded spice has been used. The disposable spice containers may be constructed such that the containers are tamper resistant inhibiting users from opening the containers.

In some embodiments, a first spice container may be reusable. The first spice container may be refillable. Reusable spice containers may be formed from more durable components such that the containers withstand prolonged use, as opposed to disposable spice containers. In some embodiments, the spice container may be refilled by removing the grinding mechanism. Upon removing the grinding mechanism spice may be added into the first opening by a user. For example, he grinding mechanism may be screwed into the first opening or the grinding mechanism may couple to the first opening in a press-fit arrangement.

In some embodiments, one or more elongated members 240 may be coupled to electric motor 130 and to grinding mechanism 170 during use. When the electric motor is activated the elongated member conveys that mechanical action produced by the electric motor to the grinding mechanism in order to grind spices in the spice container. In some embodiments, elongated members 240 may couple to grinding mechanism 170 using gears 250 (e.g., as depicted in FIG. 2).

In some embodiments, an electric motor when activated may turn a portion of the powered base. The portion of the powered base may be coupled to grinding mechanism 170 such that when the portion turns the grinding mechanism is activated and dispenses spices from the spice container. In some embodiments, the portion may couple to the grinding mechanism such that only the grinding mechanism moves relative to the spice container.

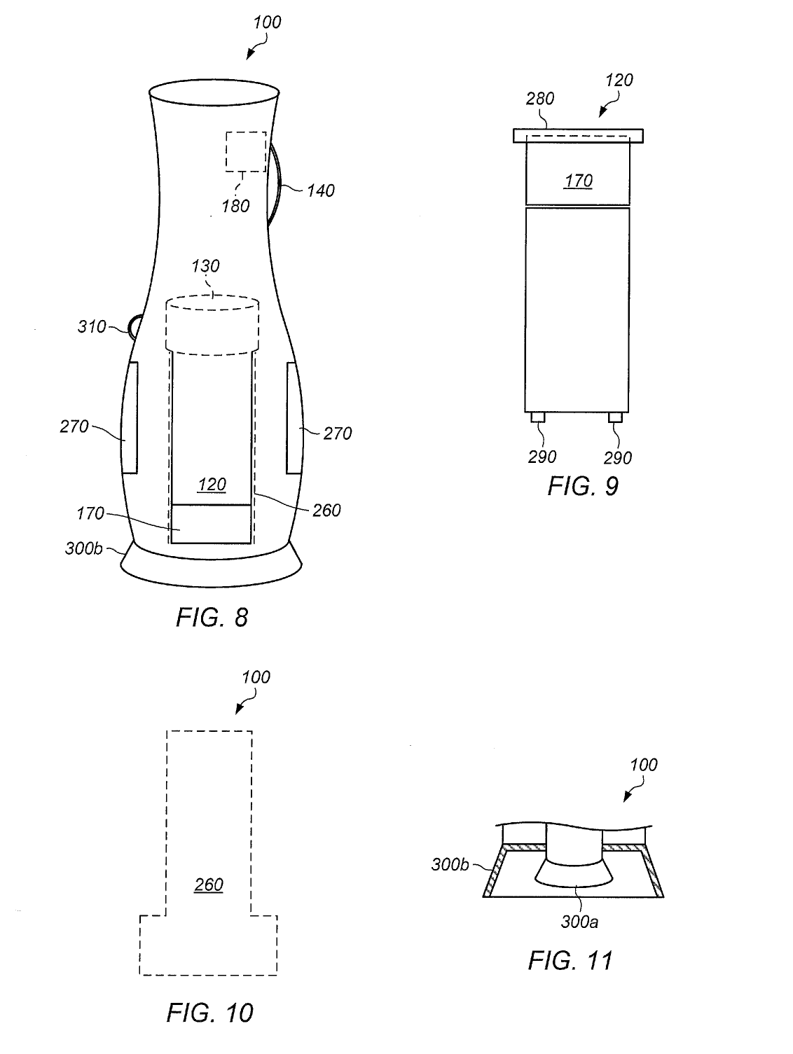

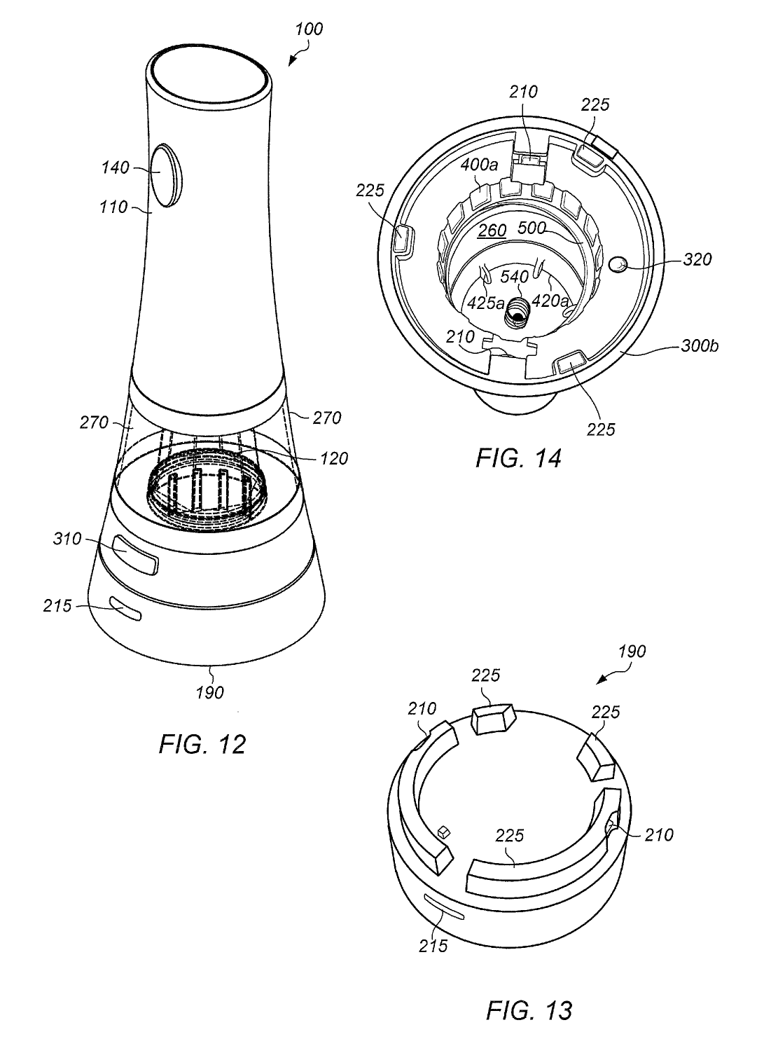

In some embodiments, the portion may couple to the spice container such that when the portion of the powered base turns a portion of the spice container turns which activates the grinding mechanism dispensing spices from the spice container. FIG. 8 depicts a diagram of a side view of an embodiment of a spice grinding system 100. FIG. 12 depicts a diagram of a perspective view of an embodiment of spice grinding system 100 including recharging station 190. FIG. 14 depicts a diagram of a bottom perspective view of an embodiment of powered base 110 of spice grinding system 100. In some ways the embodiments depicted in FIG. 8 may function similarly to other embodiments discussed herein. System 100 may include electric motor 130 coupled to spice container 120 when the spice container is positioned in opening 260 of system 100. Spice container 120 may include grinding mechanism 170.

In some embodiments, a portion of the opening adjacent the grinding mechanism may inhibit movement of the grinding mechanism relative to the spice container during use. The portion of the opening may inhibit movement of the grinding mechanism by including at least a portion which has a size and/or shape which is complementary to an outer perimeter of the grinding mechanism. In some embodiments, at least one of the second portion of the opening or the second end portion of the first spice container may include at least three cornered portions and the other of the second portion of the opening or the second end portion of the first spice container may include at least three elongated members. In some embodiments, at least one of the first portion of the opening or the first end portion of the first spice container may include at least two splines and the other of the first portion of the opening or the first end portion of the first spice container may include at least two indentations.

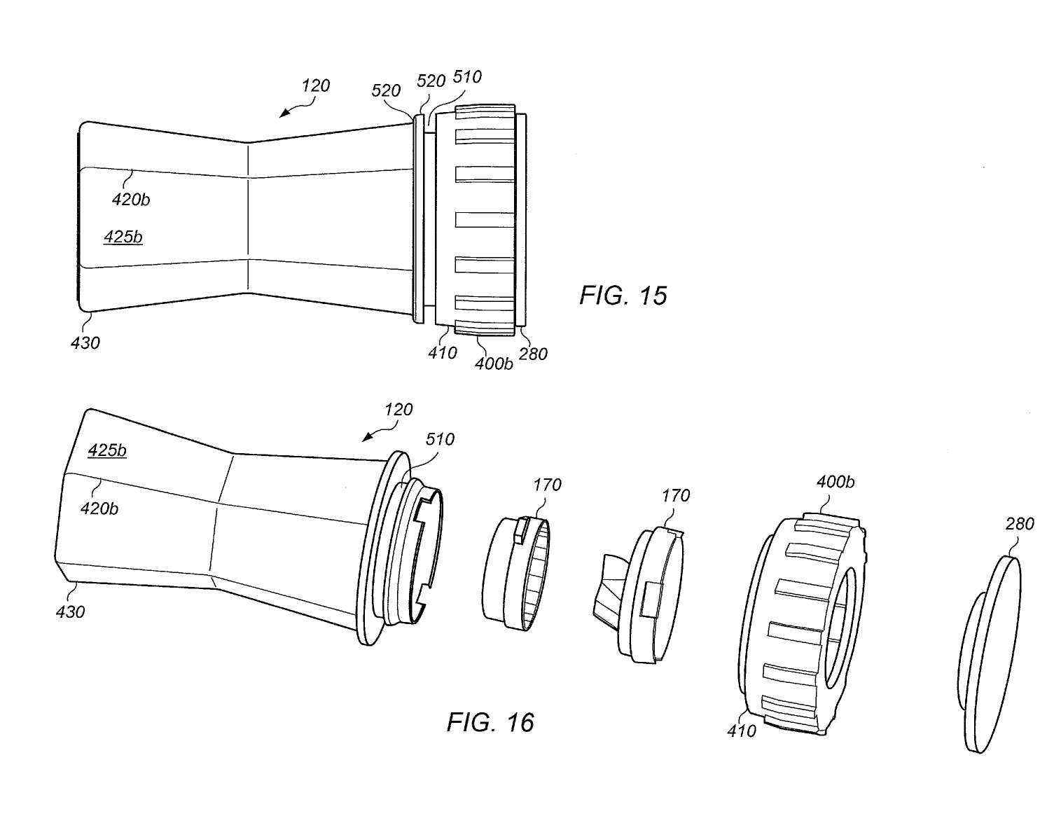

In some embodiments, the first spice container may be positioned in an opening of the powered base (e.g., as depicted in FIGS. 12 and 14). A first portion of the opening may include a shape (e.g., indentations 400a as depicted in FIG. 14) complementary to first end portion 410 (e.g., detents 400b (or splines) as depicted in FIG. 15) of the first spice container housing the grinding mechanism. A second portion of the opening may include a second shape (e.g., indentations 420a as defined by stops 425a (or splines) as depicted in FIG. 14) complementary to second end portion 430 (e.g., corners 420b as defined by sides 425b as depicted in FIG. 15), opposite first end portion 410, of the first spice container such that when the electric motor is activated the second portion of the opening rotates engaging and rotating the second end portion of the first spice container while the first portion of the opening engages the first end portion of the first spice container inhibiting rotational movement of the first end portion as the second end portion is rotated (resulting in the grinding mechanism grinding spices contained in the first spice container). For example, stops 425a may engage sides 425b to turn second end portion 430 of first spice container 120 relative to first end portion 410 during use as the first end portion is held relatively rotationally stationary by indentations 400a engaging detents 400b. In some embodiments, indentations 400a engaging detents 400b may be shaped such that first spice container 120 does not insert beyond a predetermined depth into opening 260. In alternate embodiments, the different shapes discussed which engage one another may be reversed as to whether the shape is built into the spice container or the opening of the powered base.

In some embodiments, the arrangement may be reversed and the electric motor upon activation may turn the grinding mechanism relative to the spice container.

As mentioned, a second portion of the spice container may be coupled to electric motor 130. When the electric motor is activated, during use, the electric motor may turn the second portion of the spice container to which it is coupled. As the spice container turns relative to the grinding mechanism, gravity and the grinding mechanism work to grind spices relative within the spice container such that they are expelled from the spice container. In some embodiments, for example a spice container with a substantially square cross-section, the grinding mechanism may turn about ninety degrees and/or multiples of ninety degrees at a time such that the grinding mechanism is always in alignment with the rest of the spice container as relates to the cross-sections of the two. This may be important, depending upon the embodiment, for facilitating removal of the spice container when desired (due to a complementary shape of the opening in system 100 which the spice container is positioned in during use). FIG. 10 depicts a diagram of a side view of an embodiment of at least a portion of spice grinding system 100, specifically an opening into which a spice container is inserted. In this embodiment, the opening may have a complementary size and shape for part of the spice container and then increase in diameter towards the bottom such that grinding mechanism 170 may rotate freely such that the grinding mechanism need not be aligned with the rest of the spice container to be inserted/removed from system 100.

In some embodiments, system 100 may include one or more openings or transparent portions 270. In the embodiment of system 100 depicted in FIG. 8, system 100 may include two transparent windows 270 which allow a user to view a spice container when the spice container is positioned in system 100. This may allow a user to tell by visual inspection what spice is currently positioned in system 100. In some embodiments, one or more portions of the spice container may be transparent such that a user looking through the transparent window may see what spice is positioned in the spice container. In some embodiments, a picture and/or the name of the spice may be coupled to the spice container such that a user looking through the transparent window may see what spice is positioned in the spice container.

In some embodiments, the powered base may include a light 320 (e.g., as depicted in FIG. 14). The light, during use, may light up an area substantially adjacent the grinding mechanism of the first spice container. The light may allow, for example, a user to better view how much and/or where spice is dispensed. The light may be activated by the controller during use.

In some embodiments, system 100 may include release mechanism 310. When spice container 120 is positioned in the system a securing mechanism may engage the spice container such that it is inhibited from removal. In some embodiments, a securing mechanism may include a member which engages an opening, detent, or edge of a spice container. The member may be flexible or positionable (e.g., attached to a spring) such that as the spice container is positioned in the opening of the grinding system 100 the member moves out of the way as the spice container presses against the member until the member engages the opening inhibiting further movement. Release mechanism 310 may function to disengage the securing mechanism such that a spice container can be removed from an opening in system 100.

In some embodiments, the securing member may include a lock. The lock which when activated, during use, may inhibit the first spice container from decoupling from the powered base. The lock may include at least one locking member 500 (e.g., as depicted in FIG. 14) which each engage depression 510 (e.g., as depicted in FIGS. 15-16) on first spice container 120 upon insertion of the first spice container in the opening of powered base 110. At least one of the locking members may include a ring (e.g., as depicted in FIG. 14) which engages at least a majority of depression 510 substantially extending around a circumference of the first spice container. In some embodiments, a lock may include at least two locking members (e.g., two rings) which function to engage at least two depressions.

In some embodiments, locking member 500 may be biased such that the locking member is in a locked position as depicted in FIG. 14. A spring may keep the locking member in a biased position. As the first spice container is positioned in opening 260 a portion (e.g., lip 520) of the first spice container may reposition the locking member to an unlocked position until indentation 510 engages the locking member by allowing the locking member to be repositioned into the locked position. Lip 520 and/or locking member 500 may include rounded edge 530 allowing the lip to easier bypass and inhibit engagement between the two. At least a portion of first end portion 410 may be sized such that it does not pass by locking member 500. Release mechanism 310 may function to disengage the locking member 500 such that a spice container can be removed from an opening in system 100. For example, when a user applies an adequate amount of force to the release mechanism (e.g., a button which is coupled to the locking member) the force applied overcomes the bias force applied by the spring to the locking member such that the locking member disengages from indentation 510.

In some embodiments, the release mechanism may ejection system 540. The ejection system may apply pressure to the spice container to facilitate removal of the spice container from the opening in system 100. The ejection system may include a spring (e.g., as depicted in FIG. 14). The spring may apply pressure to second 430 of first spice container 120 during use. When engaged, locking member 510 may inhibit ejection system 540 from at least partially ejecting the first spice container from opening 260. Upon disengaging the locking member the ejection system may eject the first spice container at least partially from the opening in the powered base.

FIG. 9 depicts a diagram of a side view of an embodiment of spice container 120 of spice grinding system 100. The spice container may include grinding mechanism 170. In some embodiments, the grinding mechanism may include sealing member 280 coupled to the grinding mechanism. Sealing member 280 may function to preserve the freshness of any spices container in the spice container until needed. The sealing member may, in some embodiments, be reusable in that it may be removed and then later repositioned if a user wishes to store the spice for later use after having removed the sealing member. In some embodiments, a sealing member may not be reusable. The sealing member may not be reusable for safety reasons (e.g., such that a user knows if a spice container has been tampered with). A reusable and a disposable sealing member may be used to provide a user safety and convenience. In some embodiments, spice container 120 may include coupling members 290 (e.g., as depicted in FIG. 9). Coupling members 290 may be positionable in openings in system 100 during use. In some embodiments, coupling members may function to align the spice container during insertion and/or use. In some embodiments, coupling members may assist in coupling the spice container to system 100 (e.g., to the electric motor).

FIG. 11 depicts a diagram of a side view of an embodiment of a bottom portion of spice grinding system 100. In some embodiments, a portion of grinding mechanism 170 may include flared sides 300a extending out from the grinding mechanism. Flared sides 300a may function to inhibit freshly ground spices from coming into contact with adjacent portions of system 100 such that as spice containers are interchanged you have less chance of cross contamination of spices which in some instances can be dangerous (e.g., allergies). In some embodiments, a similar effect may be accomplished, although maybe less effectively, by ensuring that once positioned at least a portion of the grinding mechanism extends slightly below adjacent portions of system 100. In some embodiments, a bottom portion of system 100 may include flared sides 300b (e.g., as depicted in FIGS. 8, 11, and 14). These flares may function to inhibit the grinding mechanism of the spice container from touching a surface onto which system 100 is placed to, for example, inhibit contamination of the grinding mechanism.

In some embodiments, a grinding mechanism may include a burr grinder. A grinding mechanism may include at least one ceramic grinder. A grinding mechanism may include at least one plastic grinder.

In some embodiments, the first spice container may include a second opening. The second opening may be coupled to the first opening. The first spice container may be refilled by adding spice through the second opening in the first spice container. The second opening may be resealable using a variety of closure systems. For example, a rigid, a semi-rigid, or pliable plug may be used to reseal the second opening in, for example, a press-fit closure arrangement. In some embodiments, the a second end portion of the spice container, opposite of a first end portion including the grinding mechanism, may open up, for example, by unscrewing the end portion such that the spice container may be filled by a user with spice.

In some embodiments, a spice grinding system may include at least a second spice container. The second spice container may include a second spice. The first and second spice may be the same or different spices. In some embodiments, a spice grinding system may include a plurality of spice containers which may be used in combination with, typically, one powered base or multiple powered bases. A plurality of individual spice containers may allow a user to efficiently interchange spice containers while cooking so that a user may add different ground spices.

In some embodiments, a first spice container may include at least one transparent portion such that materials contained therein may be observed by a user. In some embodiments, at least a majority of a body of a spice container may be formed from a substantially transparent plastic such that a user may identify what type and/or amount of spice contained therein. In some embodiments, a spice container may include a label for identifying the spice therein. The label may be reusable, for example, one may be able to erase the label and reuse it. The spice container may come with multiple labels preprinted with common spice names and/or a plurality of blank labels a user may fill in.

One advantage of embodiments described herein, wherein a spice container includes the grinding mechanism as part of the spice container unit, is that different spices may be inhibited from unintentionally commingling as compared to spice grinder which use the same grinding mechanism for whatever spice is used. Current spice grinders use the same grinding mechanism for grinding whatever spice is positioned in the spice grinder which leads to commingling of spices as they are interchanged, unless of course a user meticulously cleans not only the interior of the spice container but also the grinding mechanism itself to remove previously ground spice residue.

FIG. 4 depicts a diagram of a perspective view of an embodiment of powered base 110 of spice grinding system 100. In some embodiments, powered base 110 may include control system 140. The control system may function to activate electric motor 130. The control system may function to activate the electric motor for a specified amount of time such that a predetermined amount of spice is ground and dispensed. The amount of time may be set by a user. In some embodiments, a user may manually set a dial to a specific setting (e.g., a number, letter, etc.). The user may know what setting to set the dial at by referencing a chart or packaging which comes with the spice grinding system or the spice container. In some embodiments, a spice container may include marking which let a user know what to set a dial to, which would be dependent on the type of spice contained in the spice container. Different types of spices require different amounts of grinding to achieve a specific amount (e.g., a teaspoon) of ground spice, hence different settings account for this fact. Such a system may be advantageous for grinding systems which use reusable spice containers, such that a reader may simply reference a chart to determine what setting to input dependent upon what type of spice they put into the spice container. For example, the control system may function to activate the electric motor runs long enough to dispense a teaspoon or a tablespoon or one or more fractions of such measurements. In some embodiments, a spice positioned in the spice container may not require grinding. In such embodiments a grinding system may function not to grind the spice when activated but to merely dispense the spice in the desired amount. In such embodiments, the grinding system may not be a grinding system at all but a system which merely inhibits a spice from exiting the container until activated.

In some embodiments, a control system may determine an appropriate amount of time for a spice grinding system to be activated in a substantially automated fashion with little to no effort expended by a user to determine the appropriate amount of time. In some embodiments, a user may not have to expend any effort to recalibrate a control system to determine an appropriate amount of time for a spice grinding system to be activated once the control system is engaged. A control system may include a reader system which automatically adjusts the activation time once the control system is engaged by a user. In some embodiments, a control system may include a barcode reader which reads a barcode on a spice container upon the spice container being inserted into the powered base. The barcode may inform the control system at least how long the activation time should be. In some embodiments, a series of electrical contact points may be used to inform the control system at least how long the activation time should be. Contact points may be formed from an electrically conductive material (e.g., metal). A pattern of metal contact points may be positioned on a portion of a spice container, which when coupled to a powered base may inform the control system at least how long the activation time should be when the control system is engaged. In some embodiments, a control system may have a manual override such that a user may input a different setting other than the one identified by the spice container. This may allow a user more freedom in the way the grinding system is used and/or allow a user to correct an error resulting from the automated system.

In some embodiments, powered base 110 may include energy source 180. In some embodiments, the energy source may be provided by a building's electrical system. The electricity to the building is provided by any number of methods or systems known to one skilled in the art including, but not limited to, a local electrical power grid, solar panels, wind tower, or a generator. The powered base may be connected to the electrical power grid through an electrical cord of an appropriate gauge based upon the electrical power provided.

In some embodiments, the energy source may include power sources which are not connected to any outside electrical grid. The energy source may include, for example, disposable standardized batteries may be used as an energy source.

In some embodiments, the energy source may be rechargeable. There are a variety of known rechargeable energy sources. In some embodiments, rechargeable energy sources may include nonproprietary aftermarket batteries, for example, NiMH rechargeable batteries. The powered base may include a compartment specifically designed to handle one or more sizes of nonproprietary standardized aftermarket batteries (e.g., AA, AAA, etc.). Such a compartment may allow a user to more easily replace a rechargeable energy source under such circumstances as the energy source fails and needs to be replaced. In some embodiments, rechargeable energy sources may include proprietary batteries, such that replacements are only available from the manufacturer and/or a licensed representative. The batteries may come in a nonstandard shape. This may advantageously allow for more efficient batteries to designed for a grinding system making efficient use of available space within the powered base. Nonstandard batteries may create a separate revenue stream for a manufacturer, as replacement batteries are required by purchasers of the grinding system must then purchase the replacement batteries from the manufacturer of the grinding system.

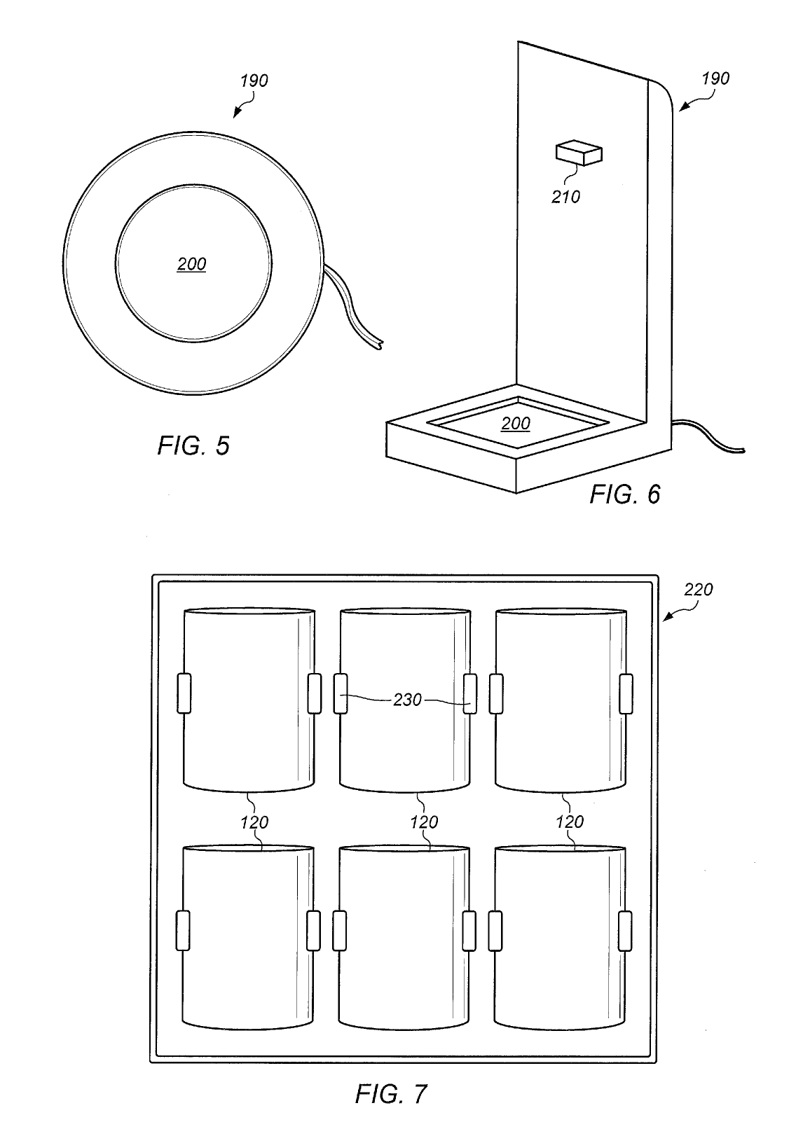

A spice grinding system may include a recharging station. FIGS. 5-6 and 12-13 depict embodiments of recharging stations 190. FIG. 5 depicts a diagram of a top view of an embodiment of recharging station 190 of spice grinding system 100. FIGS. 6 and 13 depict a diagram of a perspective view of an embodiment of recharging station 190 of spice grinding system 100. The recharging station may include indicator 215 (e.g., as depicted in FIGS. 12-13). The indicator may alert users when the powered base is charging using the recharging station. The indicator may include a light. Recharging station 190 may include aligning members 225. Aligning members 225 (e.g., on the powered base and the recharging station, for example, as depicted in FIGS. 13-14) may function to appropriately position the powered base on the charging station such that electrical contact 210 align with the contacts on the powered base. The recharging station may function to electrically couple to the rechargeable energy source during use. The recharging station may electrically couple to the rechargeable energy source using one or more methods.

In some embodiments, a recharging station may include a relatively small charging station to which a rechargeable energy source directly couples. In that the rechargeable energy source may be removed from the grinding system and coupled to the charging station. Advantages of such a system are that the recharging station is small and easily stored and/or transported.

In some embodiments, a charging station may be electrically coupled through a grinding system. Metallic contacts in on a bottom of a spice container and/or a powered base may be electrically coupled to an energy source. In such an embodiment a powered base and/or a spice container may be simply positioned in depression 200 of recharging station 190. Depression 200 (e.g., depicted in FIGS. 5-6) my function to properly align, for example, electrical contact 210, of a grinding system with electrical contact 210 of recharging station 190. In some embodiments, depression 200 may function as electrical contact 210. The grinding system may simply be positioned on top of or adjacent the recharging station such that one or more portions of the grinding system are in contact with the charging station. Portions of the grinding system may be in contact with the recharging station such that the rechargeable energy source of the grinding system is electrically coupled to the charging station. The rechargeable energy source may be electrically coupled to the charging station through electrically conductive metal contacts or plates. In some embodiments, the grinding system may be coupled to the charging station using a plug mechanism.

In some embodiments, a spice grinding system may include a storage system. FIG. 7 depicts a diagram of a front view of an embodiment of storage system 220 of spice grinding system 100. Storage system 220 may function to contain and/or organize a plurality of spice containers 120. The storage system may assist a user in accessing a variety of different spice container, typically containing a variety of spices. The storage system may be sold as a set along with the spice containers, and in some instances the spice containers may come prefilled with a variety of popular spices. In some embodiments, a storage system may be freestanding. Storage system 220 may include clips 230. The clips may function to inhibit movement of the spice containers once positioned by, for example, a user. Clips may form a friction fit with the spice containers. Other methods may be used to inhibit movement of positioned spice containers (e.g., magnets).

In some embodiments, a storage system may be mountable to a wall. The storage system may be convertible such that a user may either set the storage system up freestanding or mount it to a vertical surface.

In some embodiments, a method of grinding spices may include using a system as described herein.

In some embodiments, a method of grinding spices may include coupling a first spice container to a powered base. The first spice container may include a first spice positioned in a first opening of the first spice container. The method may include activating a control system to activate an electric motor. The electric motor may be positioned in the powered base. The method may include grinding at least a portion of the first spice using a grinding system powered by the electric motor. The method may include decoupling the first spice container from the powered base. The method may include coupling a second spice container to a powered base. The second spice container may include a second spice positioned in a second opening of the second spice container. The method may include activating the control system to activate the electric motor. The method may include grinding at least a portion of the second spice using a second grinding system powered by the electric motor.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A spice grinding system, comprising:
a powered base, comprising:
an electric motor; and
a control system configured to activate the electric motor; and
a first spice container, wherein the first spice container is releasably couplable to the powered base, and wherein the first spice container comprises:
a first opening in the first spice container configured to contain spice; and
a grinding/sifting mechanism which inhibits spice positioned in the first opening from exiting the first opening prior to activation of the grinding/sifting mechanism by the electric motor, wherein the powered base is configured to rotate a portion of the first spice container and simultaneously inhibit another portion of the first spice container from rotating, in order to grind/sift spice in the first spice container.

2. (canceled)

3. The system of claim 1, wherein the powered base further comprises an energy source.

4. The system of claim 1, wherein the powered base further comprises a rechargeable energy source.

5. (canceled)

6. (canceled)

7. The system of claim 1, wherein the first spice container comprises a first spice.

8. The system of claim 1, wherein the first spice container is disposable.

9. The system of claim 1, further comprising at least a second spice container.

10. The system of claim 1, further comprising at least a second spice container, wherein at least the second spice container comprises a second spice.

11. The system of claim 1, wherein the first spice container comprises a second opening allowing a user to position, during use, at least the first spice in the first opening.

12. (canceled)

13. (canceled)

14. (canceled)

15. (canceled)

16. (canceled)

17. The system of claim 1, wherein at least a portion of the powered base is transparent such that spice in the first spice container can be viewed by a user when the first spice container is substantially in an opening of the powered base.

18. The system of claim 1, wherein the control system is configured to activate the electric motor for a specified amount of time such that a predetermined amount of spice is ground and dispensed.

19. The system of claim 1, wherein the control system is configured to activate the electric motor for a specified amount of time such that a predetermined amount of spice is ground and dispensed, wherein the amount of time is set by a user.

20. The system of claim 1, wherein the powered base further comprises a light which during use lights up an area substantially adjacent the grinding/sifting mechanism of the first spice container, and wherein the light is activated by the controller during use.

21. (canceled)

22. The system of claim 1, wherein the first spice container is positioned in an opening of the powered base, wherein a first portion of the opening of the powered base comprises a shape at least partially complementary to a first end portion of the first spice container housing the grinding/sifting mechanism and a second portion of the opening of the powered base comprises a second shape at least partially complementary to a second end, opposite the first end, of the first spice container such that when the electric motor is activated the second portion of the opening rotates engaging and rotating the second end portion of the first spice container while the first portion of the opening engages the first end portion of the first spice container inhibiting rotational movement of the first end portion.

23. The system of claim 22, wherein at least one of the second portion of the opening or the second end portion of the first spice container comprises at least three cornered portions and the other of the second portion of the opening or the second end portion of the first spice container comprises at least three elongated members, and wherein at least one of the first portion of the opening or the first end portion of the first spice container comprises at least two splines and the other of the first portion of the opening or the first end portion of the first spice container comprises at least two indentations.

24. The system of claim 1, wherein the powered base comprises a lock which, when activated during use, inhibits the first spice container from decoupling from the powered base.

25. The system of claim 1, wherein the powered base comprises a lock which, when activated during use, inhibits the first spice container from decoupling from the powered base, and wherein the lock comprises at least one locking member which engages a depression on the first spice container upon insertion of the first spice container.

26. The system of claim 1, wherein the powered base comprises a lock which, when activated during use, inhibits the first spice container from decoupling from the powered base, wherein the lock comprises at least one locking member which engages a depression on the first spice container upon insertion of the first spice container, and wherein at least one of the locking members comprises at least a portion of a ring and the depression substantially extends around at least a portion of a circumference of the first spice container.

27. The system of claim 1, wherein the grinding/sifting mechanism comprises a grinding/sifting selector which, upon activation, changes an average size of the ground spice.

28-39. (canceled)

40. A spice container, comprising:
a first opening in a spice container configured to contain spice; and
a grinding/sifting mechanism which inhibits spice positioned in the first opening from exiting the first opening prior to activation of the grinding/sifting mechanism by an electric motor positioned in a powered base, wherein the grinding/sifting mechanism is configured to grind the spice, upon activation, such that the spice is reduced in size to such an extent as to pass out of the first opening and through the grinding/sifting mechanism, and wherein the spice container is releasably couplable to the powered base.

41-52. (canceled)

53. A spice grinding system, comprising:
a powered base, comprising:
an electric motor; and
a control system configured to activate the electric motor; and
a first spice container, wherein the first spice container is releasably couplable to the powered base, and wherein the first spice container comprises:
a first opening in the first spice container configured to contain spice; and
a grinding/sifting mechanism which inhibits spice positioned in the first opening from exiting the first opening prior to activation of the grinding/sifting mechanism by the electric motor, wherein the powered base is configured to rotate a portion of the first spice container and simultaneously inhibit another portion of the first spice container from rotating, in order to grind/sift spice in the first spice container;
wherein the first spice container is positioned in an opening of the powered base, wherein a first portion of the opening of the powered base comprises a shape at least partially complementary to a first end portion of the first spice container housing the grinding/sifting mechanism and a second portion of the opening of the powered base comprises a second shape at least partially complementary to a second end, opposite the first end, of the first spice container such that when the electric motor is activated the second portion of the opening rotates engaging and rotating the second end portion of the first spice container while the first portion of the opening engages the first end portion of the first spice container inhibiting rotational movement of the first end portion.

54. A spice grinding system, comprising:
a powered base, comprising:
an electric motor; and
a control system configured to activate the electric motor; and
a first spice container, wherein the first spice container is releasably couplable to the powered base, and wherein the first spice container comprises:
a first opening in the first spice container configured to contain spice; and
a grinding/sifting mechanism which inhibits spice positioned in the first opening from exiting the first opening prior to activation of the grinding/sifting mechanism by the electric motor, wherein the powered base is configured to rotate a portion of the first spice container and simultaneously inhibit another portion of the first spice container from rotating, in order to grind/sift spice in the first spice container; wherein the powered base comprises a lock which, when activated during use, inhibits the first spice container from decoupling from the powered base, wherein the lock comprises at least one locking member which engages a depression on the first spice container upon insertion of the first spice container, and wherein at least one of the locking members comprises at least a portion of a ring and the depression substantially extends around at least a portion of a circumference of the first spice container.
